(19) United States
(12) Patent Application Publication
(10) Pub. No.: US 2016/0028618 A1
(43) Pub. Date: Jan. 28, 2016

(54) METHOD OF COMMUNICATING INFORMATION OVER A NETWORK AND A SYSTEM FOR COMMUNICATING INFORMATION OVER A NETWORK

(71) Applicant: Telekom Malaysia Berhad, Kuala Lumpur (MY)

(72) Inventors: Ahmad Syamil WAHID, Sepang (MY); Jalil DESA, Pusat Bandar Puchong (MY); Noor Mohammed ASRAF, Petaling Jaya (MY); Wan Noorashikeen DAUD, Shah Alam (MY); Yante MOHD NOR, Kajang (MY)

(21) Appl. No.: 14/804,431

(22) Filed: Jul. 21, 2015

(30) Foreign Application Priority Data
Jul. 25, 2014 (MY) PI 2014702054

(51) Int. Cl. H04L 12/725; H04L 12/931; H04L 12/751

(52) U.S. Cl. CPC H04L 45/302; H04L 45/02; H04L 49/70

(57) ABSTRACT

A method of communicating information over a network is described. The method comprises the steps of providing at least one traffic distribution controller arranged to communicate information between a source and a destination over the communications network. The controller is implemented to perform software-based routing based on a software defined networking paradigm. The method also comprises determining a plurality of routes between the source and the destination within the network and assigning a plurality of route quality values to each of the plurality of routes based on a determination of a plurality of qualities of each of the plurality of routes.

### FIELD OF THE INVENTION

The present invention relates to a method of communicating information over a network, and to a network communication system.

### BACKGROUND OF THE INVENTION

Network path computation or routing in virtual networks differs from routing that is performed using specialized hardware and network operating systems. In the latter approach, the network operating system, often embedded within the network equipment, determines the route taken by a packet. Route tables stored in specialized hardware, such as an application-specific integrated circuit (ASIC), facilitate the processing of routes. However, in the case of virtual routers that run over a hypervisor, network interfaces and ports are abstracted and need to effectively interface with physical interfaces. Unlike the embedded network operating system in a typical router, the controller for a virtual router can be decoupled from the machine that hosts the virtual router and be hosted separately. The separation of functionalities (i.e. control of routes from forwarding) is known as Software Defined Networking, based on an emerging network design paradigm. Further, existing routing algorithms are not fully suitable to perform routing for virtual routers.

A typical label switched network consists of a sequence of label switching equipment that route packets to their destinations. This involves establishing a route encompassing client terminals and intermediate equipment that switch the flow of data to corresponding destinations. The path computation is determined by adding labels to routing headers indicating the type of payload being transported and its next hop. These labels are interpreted by label switching devices (using standards such as GMPLS, MPLS) for packet forwarding. Several types of services and media that peruse label switched networks impose specific quality of service (QoS) requirements, which need to be fulfilled in order to transport the packet to its intended destination. While the labels can represent policy information, they do not include dynamically modified application specific information or a centralized control of such a method. For example, these methods cannot be used for blocking a specific application without any additional security products. Meeting such requirements remains part of most service provider Service Level Agreements (SLA). However, such networks are not entirely suitable to tag multiple traffic requirements simultaneously. Additionally, there is usually only a single route available for data transmission that fulfils a limited number of traffic criteria.

Subsequently, the adoption of cloud-based service delivery models has seen network equipment deployed as virtual machines (i.e. a software instance) over a hypervisor. Virtualising networking that is based on application requirements offers many economic advantages such as rapid scalability, configuration and management since the network equipment is run as software. However, such a mode of delivery can also impose stress due to a concentration of traffic at a specific point in the network.

### SUMMARY OF THE INVENTION

In accordance with a first aspect of the present invention, there is provided a method of communicating information over a network, the method comprising the steps of:
providing at least one traffic distribution controller arranged to communicate information between a source and a destination over a communications network, the controller being arranged to perform software-based routing based on a software defined networking paradigm;
determining a plurality of routes between the source and the destination within the network;
assigning a plurality of route quality values to each of the plurality of routes based on a determination of a plurality of qualities of each of the plurality of routes;
comparing the route quality values of each of the plurality of routes;
determining a non-dominated set of the routes based on the step of comparing the route quality values of each of the plurality of routes; and
selecting a route from the non-dominated set of routes for communicating the information over the selected route.

Selecting a route from a non-dominated set of routes facilitates selection of an appropriate route without necessarily requiring a narrow set of criteria (or giving up on the quality of another criteria) to be satisfied. It will be appreciated that any route of the non-dominated set of routes may be selected. If network conditions change, then a further route of the non-dominated set of routes may be selected. Further, routes that are part of the non-dominated set may be ranked relative to one another, and selection of the route may be based on the ranking of the route.

The plurality of routes between the source and the destination within the network may be determined by performing a topology discovery process. The topology discovery process may comprise an open shortest path first (OSPF) process. Requirements of users of the network may also be determined, along with quality of service (QoS) requirements, for example using an eXtensible Markup Language (XML)-based network management protocol, a network configuration protocol (NETCONF) and/or a simple network management protocol (SNMP). Information obtained during these steps may be stored in a database, for example a relational database. It will be appreciated that the routes discovered at this stage are potential routes for selection.

Assigning the plurality of route quality values to each of the plurality of paths may comprise using an objective function to evaluate each of the plurality of routes and assigning a share score as an indicator of the quality of each evaluated route. A share score can also be used to determine a tie if the quality values of a plurality of routes are the same. The plurality of route quality values may be component parameters of the objective function. In one example, the component parameters of the objective function for each route relates to one or more of the group comprising: a time delay associated with communicating the information over the route, a bandwidth associated with the route, a hop count associated with the route, and information associated with the availability of service of the route.

In one embodiment, when comparing the route quality values of each of the plurality of routes, the plurality of route quality values are not combined.

In accordance with a second aspect of the present invention, there is provided a system for communicating information over a network, the system comprising at least one traffic distribution controller arranged to communicate information between a source and a destination over a communications network; wherein
the controller is arranged to perform software-based routing based on a software defined networking paradigm, the controller being further arranged to:
   determine a plurality of routes between the source and the destination within the network;
   assign a plurality of route quality values to each of the plurality of routes based on a determination of a plurality of qualities of each of the plurality of routes:
   compare the route quality values of each of the plurality of routes;
   determine a non-dominated set of the routes based on the step of comparing the route quality values of each of the plurality of routes; and
   select a route from the non-dominated set of routes for communicating the information over the selected route.

The controller may be arranged to rank routes that are part of the non-dominated set relative to one another, and to select a route based on the ranking of the route.

The controller may be arranged to determine the plurality of routes between the source and the destination within the network by performing a topology discovery process. Alternatively, the plurality of routes between the source and the destination within the network may be provided. The topology discovery process may comprise an open shortest path first (OSPF) process. Requirements of users of the network may also be determined, along with quality of service (QoS) requirements, for example using an eXtensible Markup Language (XML)-based network management protocol, a network configuration protocol (NETCONF) and/or a simple network management protocol (SNMP). The system may be arranged to store information obtained during these steps in a database, for example a relational database. It will be appreciated that the routes discovered at this stage are potential routes for selection.

The controller may be arranged to assign the plurality of route quality values to each of the plurality of paths by using an objective function to evaluate each of the plurality of routes and assigning a share score as an indicator of the quality of each evaluated route. A share score can also be used to determine a tie if the quality values of a plurality of routes are the same. The plurality of route quality values may be component parameters of the objective function. In one example, the component parameters of the objective function for each route relates to one or more of the group comprising: a time delay associated with communicating the information over the route, a bandwidth associated with the route, a hop count associated with the route, and information associated with the availability of service of the route.

The controller may be arranged such that, when comparing the route quality values of each of the plurality of routes, the plurality of route quality values are not combined.

### BRIEF DESCRIPTION OF THE FIGURES

Embodiments of the present invention will now be described, by way of example only, with reference to the accompanying figures, in which:

FIG. 1 is a flow chart of a method of communicating information over a network in accordance with an embodiment of the present invention;

FIG. 2 is a flow chart of a method of communicating information over a network in accordance with an embodiment of the present invention; and

FIG. 3 is a block diagram of a system for conducting the method of FIG. 1 or FIG. 2.

### DETAILED DESCRIPTION

Embodiments of the present invention facilitate the selection of routes in a network, and are appropriate for virtualized networks and services that run on hypervisors, which pose different and additional challenges than those that run directly on servers.

Unlike the embedded network operating system in a typical router, the controller for a virtual router can be decoupled from the machine that hosts the virtual router and be hosted separately. The separation of functionalities (i.e. control of routes from forwarding) is known as Software Defined Networking, based on an emerging network design paradigm. Embodiments of the present invention route a plurality of routing criteria in order to provide flexibility and improve network performance.

Further, and as discussed earlier, existing networking methods cannot be used for blocking a specific application without any additional security products. Meeting such requirements remains part of most service provider Service Level Agreements (SLA). However, such networks are not entirely suitable to tag multiple traffic requirements simultaneously. Applying embodiments of the present invention with a centralised controller can be advantageous in addressing the limitations posed by existing networking methods.

Embodiments provide a centralised network controller and a route selection method that can be modified to suit specific needs of the user to manipulate the network, and can be used to optimise different routing and application criteria. For example, different applications typically have specific service policies which, when directly manipulated via a controller, can present economic advantages.

Further, embodiments of the present invention relate to designing networks that are responsive to applications and applying dynamic policies in such conditions. In some embodiments, the system comprises one or more traffic distribution controllers that are arranged to distribute traffic between a client device and its destination via a less congested route. The controller with the disclosed implementation typically performs software-based routing based on a software defined networking paradigm. Algorithms implemented within the controller facilitate the controller in computing policy and ranking routing decisions for virtualized cloud-based routers and switches, and can be defined to provide additional virtualised network services such as firewall and anti-virus functions.

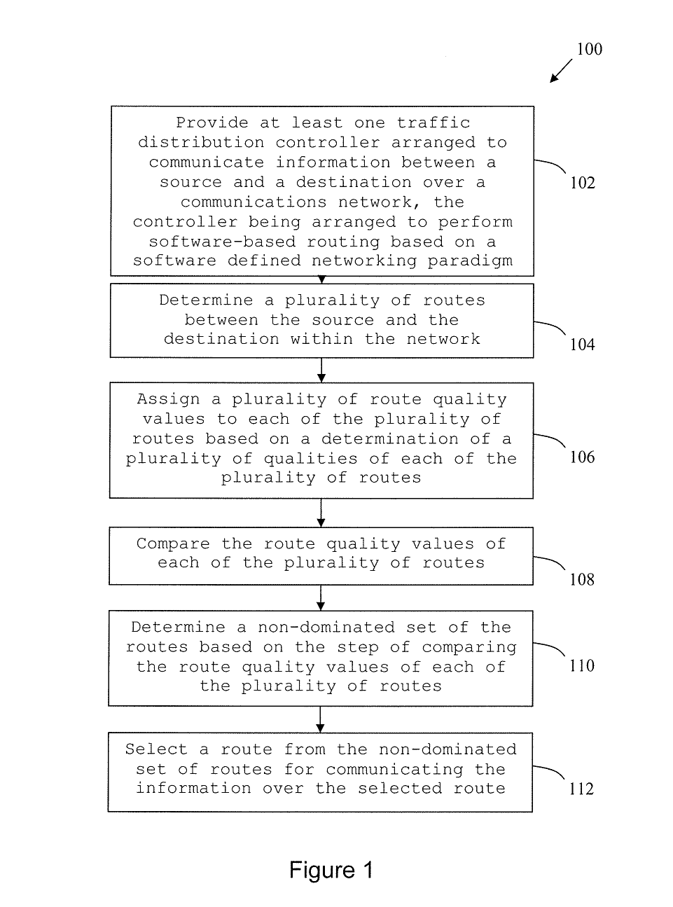

FIG. 1 is a flow chart showing a method 100 of communicating information over a network in accordance with an embodiment of the present invention. The method 100 comprises a first step 102 of providing at least one traffic distribution controller arranged to communicate information between a source and a destination over a communications network. The controller is arranged to perform software-based routing based on a software defined networking paradigm.

In a second step 104, a plurality of routes between the source and the destination within the network are determined. The plurality of routes between the client device and the destination within the network may be determined by performing a topology discovery process. In this example, the topology discovery process comprises an open shortest path first (OSPF) process. Requirements of users of the network are also determined, along with quality of service (QoS) requirements. This can be achieved using any appropriate technique, for example by using an eXtensible Markup Language (XML)-based network management protocol, a network configuration protocol (NETCONF) and/or a simple network management protocol (SNMP). Information associated with the routes obtained during these steps can be stored in a relational database, and routes discovered at this stage are potential routes for selection.

In a third step 106, a plurality of route quality values are assigned to each of the plurality of routes based on a determination of a plurality of qualities of each of the plurality of routes. In this example, the step 106 of assigning the plurality of route quality values to each of the plurality of paths comprises using an objective function to evaluate each of the plurality of routes and assigning a share score as an indicator of the quality of each evaluated route. The plurality of route quality values may be component parameters of the share value function.

In a fourth step 108, the route quality values of each of the plurality of routes are compared so as to determine, in step 110, a non-dominated set of the routes. In this example, when comparing the route quality values of each of the plurality of routes, the plurality of route quality values are not combined.

Determining 100 a non-dominated set of the routes facilitates selecting a route from the non-dominated set of routes without necessarily requiring a narrow set of criteria to be satisfied. It will be appreciated that any route of the non-dominated set of routes may be selected and, if network conditions change, then a further route of the non-dominated set of routes may be selected.

In step 112, a route from the non-dominated set of routes is selected for communicating the information over the selected route.

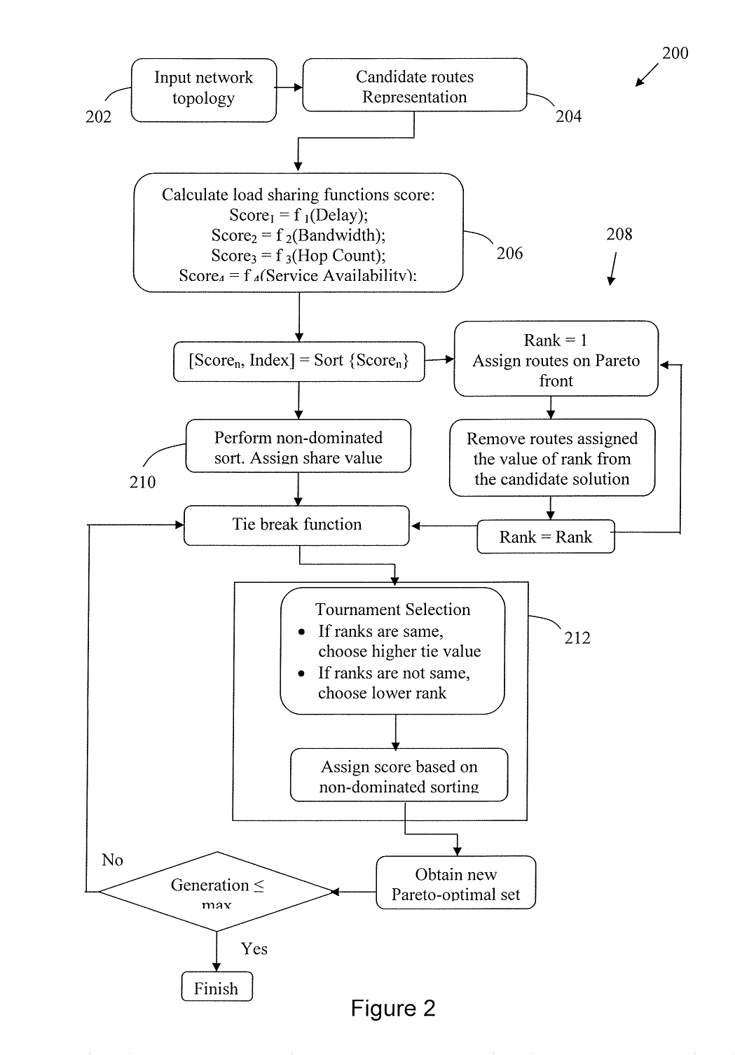

A specific method 200 of communicating information over a network will now be described with reference to FIG. 2 and the below pseudo-code.

Given:
nᵢ - Number of solutions dominated by i
sᵢ - set of solutions that are dominated by i
P - set of all non-dominated solutions
Input: Network scenario G (V, E), a source and destination(s)
Output: Set of Pareto-optimal routes
Begin

| | |
|---|---|
| 1. | Perform topology discovery to obtain candidate routes |
| 2. | Map routes with routing & application information to prioritize routes |
| 3. | Assume initial solution based on these generated routes |
| 4. | Initialise load sharing functions |
| 5. | Load Share value eval(fₖ(vᵢ)) where, k = 1, 2. . . q, and ∀ i ∈ popSize |
| 6. | Calculate share values for each function |
| 7. | Non-dominated sort (P) |
| | // iterate for all the candidate routes |
| 8. | While P ≠ { } do |
| 9. | For each solution i in the Pareto front |
| 10. | If (i dominates j) |
| | // add j to the set of solutions dominated by i |
| 11. | Sᵢ = Sᵢ ∪ {j} |
| 12. | Else If (j dominates i) |
| | // increment domination counter for i |
| 13. | nᵢ = nᵢ + 1 |
| 14. | End-If |
| | // i belongs to the first Pareto front |
| 15. | If nᵢ = 0 |
| 16. | rᵢ ← rank |
| 17. | P ←P\{vᵢ\|rᵢ = rank} |
| 18. | rank ← rank + 1 |
| 19. | Add i to the set of solutions in the first Pareto front |
| 20. | End-If |
| 21. | Tie break function for routes with same share values |
| 22. | Initialise distance = 0 |
| 23. | For k = 1 to q |
| | // sort share values in ascending order |
| 24. | Sort (ranks,>) |
| | // set boundary solutions to ∞ |
| 25. | dₗ^{k} = dₖ^{popSize} ← ∞ |
| | // difference between the maximum and minimum |
| | // values of objective i the current population |
| 26. | ${d}_{k}^{j} = \frac{{d}_{k}^{j + 1} - {d}_{k}^{j - 1}}{( {f}_{i}^{max} - {f}_{i}^{min} )} , j = 2 , … popSize - 1$ |
| | // sum of individual shares |
| 27. | ${d}_{i} ← {\sum }_{k = 1}^{q} {d}_{k}^{i} , ∀ i ∈ popSize$ |
| | // corresponding to each objective |
| 28. | If there is a change in route |
| 29. | Update mapping of routes with weights to prioritize |
| | routes and share functions |
| 30. | Re-calculate share values |
| 31. | Choose solutions with lower rank |
| | // solutions lie in the same front |
| 32. | If (rᵢ = rⱼ) |
| 33. | Choose dᵢ > dⱼ |
| 34. | Else |
| | // individual with smaller rank |
| 35. | Choose rᵢ < rⱼ |
| 36. | End-If |
| 37. | Add the new set of strings to Pareto set |
| 38. | End-While |
| 39. | Obtain new set of routes to generate a new routing table |
| 40. | Until no change in eval(fₖ(vᵢ)) \|\| (Number of share value |
| | computations ≦ maximum number of share value computations) |

As described in the above pseudo-code, and shown in FIG. 2, the method 200 comprises a sequence of steps undertaken from gathering routing states to obtaining routing decisions indicating alternative routes through which to distribute traffic. Advantageously, the method 200 facilitates re-directing traffic to less congested links and/or network devices based on service and application availability.

Congestion can occur due to multiple requests to virtualized routers from client devices.

The method 200 begins with a topology discovery process 202 (using a method such as OSPF) and gathers user requirements representing the service and QoS requirements (using a method such as XML, NETCONF and SNMP). This information is stored in a relational database and combined to represent 204 as a candidate solution as discovered routes are potential routes. Without such a combination, these routes would otherwise lack the insight of the service and QoS requirements, as there are no previously existing mechanisms to simultaneously combine both. The candidate routes are evaluated based on load share value equations.

A objective function 206 is used to evaluate candidate routes and assign a load share score as an indicator of the quality of the route considered. Candidate routes constitute hops in the network, with assigned application and policy settings that are associated with the hops. The component parameters of the share value function are not, in this example, combined as a weighted sum as this can result in a particular metric being biased. By not combining the share functions, the disclosed traffic distribution problem can be solved using a Pareto-based process. Further, given that the QoS metrics may be conflicting and interdependent in nature, it may not be possible to adequately provide a trade-off between the share values by adjusting the correct weights. Therefore, once a non-dominated set is obtained, a user is able to select a particular route based on one or more particular trade-offs rather than weighting of share functions.

For routes requiring multiple criteria, not all the criteria may be considered simultaneously as adhering to one criterion may degrade the quality of the solution obtained.

A non-dominated route is obtained 208 based on the relative share value scores. A given candidate path (A) is assigned a non-dominated rank if it dominates (has a higher rank) another candidate path (B) while at the same time A is not worse than B in all the other share functions. The solutions in the Pareto set are assigned a score based on the degree of dominance in the candidate paths and sorted in increasing order 210.

A tie-break function 212 can be used in cases where two routes have a same share function value. In such cases, the difference between the component share function value and its previous value are obtained. For example, if the share values of two candidate's values are the same, then their value and its preceding rank are taken. The candidate route with the largest share value is considered as the higher rank. This function ensures that suitable paths are considered, which in turn can be used as additional options by the source to reach its destination.

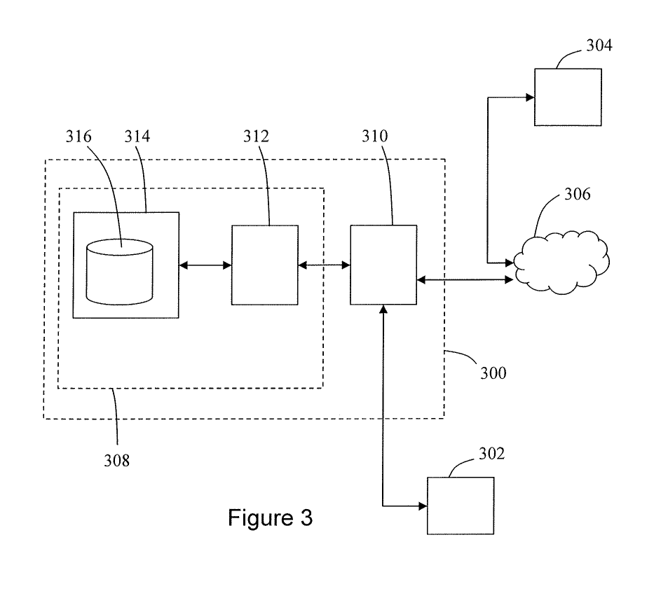

The methods 100, 200 described above can be implemented by a communications system 300 as shown in FIG. 3. The communications system 300 facilitates communicating information from a source 302, such as a first personal computer or other computing device, to a destination 304, such as a second personal computer or other computing device. The information to be communicated is sent to the communication system 300, and then via a network 306, such as the internet.

It will be appreciated that the system 300 may be any appropriate computing device that is capable of implementing a virtual router to conduct the steps of the method 100, 200. In this example, the system 300 comprises a traffic distribution controller 308 arranged to communicate the information between the source 302 and the destination 304 over the network 306. The controller 308 is arranged to perform software-based routing based on a software defined networking paradigm. As such, in this example, the controller is arranged to communicate via a network interface 310, and comprises a processor 312 and memory 314.

Computer instructions that may be required to implement software routing functions of the controller 308, and that are executed by the processor 312, are stored in the memory 314 of the controller 308. In this example, the memory 314 also comprises a database 316, which may store information associated with routes obtained during steps of the method 100, 200. In this example, the database 316 is a relational database, and includes information associated with routes that are potential routes for selection.

The system 300 is arranged to carry out the steps of the method 100, 200. In particular, the controller 308 is arranged to determining a plurality of routes between the source 302 and the destination 304, and to assigning a plurality of route quality values to each of the plurality of routes based on a determination of a plurality of qualities of each of the plurality of routes. The controller 308 is also arranged to compare the route quality values of each of the plurality of routes, to determine a non-dominated set of the routes based on the step of comparing the route quality values of each of the plurality of routes, and to select a route from the non-dominated set of routes for communicating the information over the selected route.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

In the description of the invention, except where the context requires otherwise due to express language or necessary implication, the words “comprise” or variations such as “comprises” or “comprising” are used in an inclusive sense, i.e. to specify the presence of the stated features, but not to preclude the presence or addition of further features in various embodiments of the invention.

1. A method of communicating information over a network, the method comprising the steps of:
providing at least one traffic distribution controller arranged to communicate information between a source and a destination over a communications network, the controller being arranged to perform software-based routing based on a software defined networking paradigm;
determining a plurality of routes between the source and the destination within the network;
assigning a plurality of route quality values to each of the plurality of routes based on a determination of a plurality of qualities of each of the plurality of routes:
comparing the route quality values of each of the plurality of routes;
determining a non-dominated set of the routes based on the step of comparing the route quality values of each of the plurality of routes; and
selecting a route from the non-dominated set of routes for communicating the information over the selected route.

2. The method of claim 1, wherein routes that are part of the non-dominated set are ranked relative to one another, and wherein selection of the route is based on the ranking of the route.

3. The method of claim 1, wherein the plurality of routes between the source and the destination within the network are determined by performing a topology discovery process.

4. The method of claim 3, wherein requirements of users of the network are also determined, along with quality of service requirements.

5. The method of claim 3, wherein information obtained in respect of the routes is stored in a database.

6. The method of claim 1, wherein assigning the plurality of route quality values to each of the plurality of paths comprises using an objective function to evaluate each of the plurality of routes and assigning a share score as an indicator of the quality of each evaluated route.

7. The method of claim 6, wherein the plurality of route quality values are component parameters of the objective function.

8. The method of claim 7, wherein the component parameters of the objective function for each route relates to one or more of the group comprising: a time delay associated with communicating the information over the route, a bandwidth associated with the route, a hop count associated with the route, and information associated with the availability of service of the route.

9. The method of claim 1, wherein, when comparing the route quality values of each of the plurality of routes, the plurality of route quality values are not combined.

10. A system for communicating information over a network, the system comprising at least one traffic distribution controller arranged to communicate information between a source and a destination over a communications network; wherein
the controller is arranged to perform software-based routing based on a software defined networking paradigm, the controller being further arranged to:
determine a plurality of routes between the source and the destination within the network;
assign a plurality of route quality values to each of the plurality of routes based on a determination of a plurality of qualities of each of the plurality of routes:
compare the route quality values of each of the plurality of routes;
determine a non-dominated set of the routes based on the step of comparing the route quality values of each of the plurality of routes; and
select a route from the non-dominated set of routes for communicating the information over the selected route.

11. The system of claim 10, wherein the controller is arranged to rank routes that are part of the non-dominated set relative to one another, and to select a route based on the ranking of the route.

12. The system of claim 10, wherein the controller is arranged to determine the plurality of routes between the source and the destination within the network by performing a topology discovery process.

13. The system of claim 12, wherein the controller is also arranged to determine requirements of users of the network, along with quality of service requirements.

14. The system of claim 12, further being arranged to store information obtained in respect of the routes in a database.

15. The system of claim 10, wherein the controller is arranged to assign the plurality of route quality values to each of the plurality of paths by using an objective function to evaluate each of the plurality of routes and assigning a share score as an indicator of the quality of each evaluated route.

16. The system of claim 15, wherein the plurality of route quality values are component parameters of the objective function.

17. The system of claim 16, wherein the component parameters of the objective function for each route relates to one or more of the group comprising: a time delay associated with communicating the information over the route, a bandwidth associated with the route, a hop count associated with the route, and information associated with the availability of service of the route.

18. The system of claim 10, wherein the controller is arranged such that, when comparing the route quality values of each of the plurality of routes, the plurality of route quality values are not combined.
